(19) United States
(12) Patent Application Publication
(10) Pub. No.: US 2024/0399794 A1
(43) Pub. Date: Dec. 5, 2024

(54) RADIAL TIRE

(71) Applicant: The Goodyear Tire & Rubber Company, Akron, OH (US)

(72) Inventors: Kiyoshi Ueyoko, Copley, OH (US); Michael William Schellenberger, II, Fairlawn, OH (US)

(21) Appl. No.: 18/325,421

(22) Filed: May 30, 2023

(51) Int. Cl. B60C 9/20

(52) U.S. Cl. CPC B60C 9/20; B60C 2009/2067

(57) ABSTRACT

A radial tire includes a pair of bead cores, a carcass having one or a plurality of carcass plies extending from one of the bead cores to the other of the bead cores in a toroidal form, a tread portion circumferentially encircling the toroidal form of the carcass, and a belt structure disposed radially between the carcass and the tread portion having a main belt layer, a first, unreinforced rubber layer disposed on a radially outer side of the main belt layer, a second, unreinforced rubber layer disposed within the main belt layer, and a protective belt layer disposed on a radially outer side of the first, unreinforced rubber layer and a radially inner side of the tread portion. A radially outermost layer of the main belt layer has a plurality of reinforcement cords each having a diameter, and the first and second, unreinforced rubber layers have first and second radial thicknesses, respectively, relative to such diameter.

### TECHNICAL FIELD

The present disclosure relates to a radial tire, and more particularly, to a radial tire, which may be suitable for an aircraft and mitigate cutting of the aircraft tire by foreign objects and the like and reduce weight of the aircraft tire.

### BACKGROUND

A conventional aircraft radial tire may be used under high internal pressure, high load, and high speeds of over 200 mph at takeoff and landing. When the tire spins at such high speeds, a crown region of the tire may grow radially outwardly due to high angular accelerations and velocity. If the tread grows radially outwardly, the tread rubber may be expanded in a circumferential direction of the tire.

Further, when the tire rides over a foreign object, the tire may be damaged, e.g., so-called “enveloping properties.” When the tread rubber expands in the circumferential direction of the tire, a resistance force against the foreign object may be weak. Further, such trampled foreign object may easily enter the tread and damage the tire.

When an amount of growth of the crown region of the tire becomes greater than opposite shoulder portions of the tire, a diameter difference of the tire may be generated. This diameter difference may cause a drag phenomenon to the rotating tire. As a result, the shoulder regions of the tread may wear sooner than the crown region of the tread thereby shortening the life of the tread and the tire. This phenomenon is called deviated wear.

In order to enhance the enveloping properties of the tread and the wearing characteristics of the tread by suppressing the growing deformation thereof, a conventional radial tire may include a belt structure disposed between a tread rubber layer and a carcass of a crown region. The belt structure may restrain growing deformation of the crown region of the tread.

In view of the above, it is an object of the present disclosure to provide an aircraft radial tire in which a diameter of a tread surface is prevented from being increased during rotation, endurance against cutting occurred by a foreign object or the like is enhanced, and a weight of the tire is reduced.

### Definitions

“Apex” means an elastomeric filler located radially above the bead core and between the plies and the turnup ply.

“Annular” means formed like a ring.

“Aspect ratio” means the ratio of a tire section height to its section width.

“Aspect ratio of a bead cross-section” means the ratio of a bead section height to its section width.

“Asymmetric tread” means a tread that has a tread pattern not symmetrical about the center plane or equatorial plane (EP) of the tire.

“Axial” and “axially” refer to lines or directions that are parallel to the axis of rotation of the tire.

“Bead” means that part of the tire comprising an annular tensile member wrapped by ply cords and shaped, with or without other reinforcement elements such as flippers, chippers, apexes, toe guards and chafers, to fit the design rim.

“Belt structure” means at least two annular layers or plies of parallel cords, woven or unwoven, underlying the tread, unanchored to the bead, and having cords inclined respect to the equatorial plane (EP) of the tire. The belt structure may also include plies of parallel cords inclined at relatively low angles, acting as restricting layers.

“Bias tire” (cross ply) means a tire in which the reinforcing cords in the carcass ply extend diagonally across the tire from bead to bead at about a 25° to 65° angle with respect to equatorial plane (EP) of the tire. If multiple plies are present, the ply cords run at opposite angles in alternating layers.

“Breakers” means at least two annular layers or plies of parallel reinforcement cords having the same angle with reference to the equatorial plane (EP) of the tire as the parallel reinforcing cords in carcass plies. Breakers are usually associated with bias tires.

“Cable” means a cord formed by twisting together two or more plied yarns.

“Carcass” means the tire structure apart from the belt structure, tread, undertread, and sidewall rubber over the plies, but including the beads.

“Casing” means the carcass, belt structure, beads, sidewalls and all other components of the tire excepting the tread and undertread, i.e., the whole tire.

“Chipper” refers to a narrow band of fabric or steel cords located in the bead area whose function is to reinforce the bead area and stabilize the radially inward most part of the sidewall.

“Circumferential” and “circumferentially” mean lines or directions extending along the perimeter of the surface of the annular tire parallel to the equatorial plane (EP) and perpendicular to the axial direction; it can also refer to the direction of the sets of adjacent circular curves whose radii define the axial curvature of the tread, as viewed in cross section.

“Cord” means one of the reinforcement strands of which the reinforcement structures of the tire are comprised.

“Cord angle” means the acute angle, left or right in a plan view of the tire, formed by a cord with respect to the equatorial plane (EP). The “cord angle” is measured in a cured but uninflated tire.

“Crown” means that portion of the tire within the width limits of the tire tread.

“Denier” means the weight in grams per 9000 meters (unit for expressing linear density). “Dtex” means the weight in grams per 1,000 meters.

“Density” means weight per unit length.

“Elastomer” means a resilient material capable of recovering size and shape after deformation.

“Equatorial plane (EP)” means the plane perpendicular to the tire's axis of rotation and passing through the center of its tread; or the plane containing the circumferential centerline of the tread.

“Fabric” means a network of essentially unidirectionally extending cords, which may be twisted, and which in turn are composed of a plurality of a multiplicity of filaments (which may also be twisted) of a high modulus material.

“Fiber” is a unit of matter, either natural or man-made that forms the basic element of filaments. Characterized by having a length at least 100 times its diameter or width.

“Filament count” means the number of filaments that make up a yarn. Example: 1000 denier polyester has approximately 190 filaments.

“Flipper” refers to a reinforcing fabric around the bead wire for strength and to tie the bead wire in the tire body.

“Footprint” means the contact patch or area of contact of the tire tread with a flat surface at zero speed and under normal load and pressure.

“Gauge” refers generally to a measurement, and specifically to a thickness measurement.

“Groove” means an elongated void area in a tread that may extend circumferentially or laterally about the tread in a straight, curved, or zigzag manner. Circumferentially and laterally extending grooves sometimes have common portions. The “groove width” may be the tread surface occupied by a groove or groove portion divided by the length of such groove or groove portion; thus, the groove width may be its average width over its length. Grooves may be of varying depths in a tire. The depth of a groove may vary around the circumference of the tread, or the depth of one groove may be constant but vary from the depth of another groove in the tire. If such narrow or wide grooves are of substantially reduced depth as compared to wide circumferential grooves, which they interconnect, they may be regarded as forming “tie bars” tending to maintain a rib-like character in the tread region involved. As used herein, a groove is intended to have a width large enough to remain open in the tires contact patch or footprint.

“High Tensile Steel (HT)” means a carbon steel with a tensile strength of at least 3400 MPa at 0.20 mm filament diameter.

“Inner” means toward the inside of the tire and “outer” means toward its exterior.

“Innerliner” means the layer or layers of elastomer or other material that form the inside surface of a tubeless tire and that contain the inflating fluid within the tire.

“Inboard side” means the side of the tire nearest the vehicle when the tire is mounted on a wheel and the wheel is mounted on the vehicle.

“LASE” is load at specified elongation.

“Lateral” means an axial direction.

“Lay length” means the distance at which a twisted filament or strand travels to make a 360 degree rotation about another filament or strand.

“Load range” means load and inflation limits for a given tire used in a specific type of service as defined by tables in The Tire and Rim Association, Inc.

“Mega tensile steel (MT)” means a carbon steel with a tensile strength of at least 4500 MPa at 0.20 mm filament diameter.

“Net contact area” means the total area of ground contacting elements between defined boundary edges divided by the gross area between the boundary edges as measured around the entire circumference of the tread.

“Net-to-gross ratio” means the total area of ground contacting tread elements between lateral edges of the tread around the entire circumference of the tread divided by the gross area of the entire circumference of the tread between the lateral edges.

“Non-directional tread” means a tread that has no preferred direction of forward travel and is not required to be positioned on a vehicle in a specific wheel position or positions to ensure that the tread pattern is aligned with the preferred direction of travel. Conversely, a directional tread pattern has a preferred direction of travel requiring specific wheel positioning.

“Normal load” means the specific design inflation pressure and load assigned by the appropriate standards organization for the service condition for the tire.

“Normal tensile steel (NT)” means a carbon steel with a tensile strength of at least 2800 MPa at 0.20 mm filament diameter.

“Outboard side” means the side of the tire farthest away from the vehicle when the tire is mounted on a wheel and the wheel is mounted on the vehicle.

“Ply” means a cord-reinforced layer of rubber-coated radially deployed or otherwise parallel cords.

“Radial” and “radially” mean directions radially toward or away from the axis of rotation of the tire.

“Radial ply structure” means the one or more carcass plies or which at least one ply has reinforcing cords oriented at an angle of between 65° and 90° with respect to the equatorial plane (EP) of the tire.

“Radial ply tire” means a belted or circumferentially-restricted pneumatic tire in which at least one ply has cords which extend from bead to bead are laid at cord angles between 65° and 90° with respect to the equatorial plane (EP) of the tire.

“Rib” means a circumferentially extending strip of rubber on the tread which is defined by at least one circumferential groove and either a second such groove or a lateral edge, the strip being laterally undivided by full-depth grooves.

“Rivet” means an open space between cords in a layer.

“Section height” means the radial distance from the nominal rim diameter to the outer diameter of the tire at its equatorial plane (EP).

“Section width” means the maximum linear distance parallel to the axis of the tire and between the exterior of its sidewalls when and after it has been inflated at normal pressure for 24 hours, but unloaded, excluding elevations of the sidewalls due to labeling, decoration or protective bands.

“Self-supporting run-flat” means a type of tire that has a structure wherein the tire structure alone is sufficiently strong to support the vehicle load when the tire is operated in the uninflated condition for limited periods of time and limited speed. The sidewall and internal surfaces of the tire may not collapse or buckle onto themselves due to the tire structure alone (e.g., no internal structures).

“Sidewall insert” means elastomer or cord reinforcements located in the sidewall region of a tire. The insert may be an addition to the carcass reinforcing ply and outer sidewall rubber that forms the outer surface of the tire.

“Sidewall” means that portion of a tire between the tread and the bead.

“Sipe” or “incision” means small slots molded into the tread elements of the tire that subdivide the tread surface and improve traction; sipes may be designed to close when within the contact patch or footprint, as distinguished from grooves.

“Spring rate” means the stiffness of tire expressed as the slope of the load deflection curve at a given pressure.

“Stiffness ratio” means the value of a control belt structure stiffness divided by the value of another belt structure stiffness when the values are determined by a fixed three point bending test having both ends of the cord supported and flexed by a load centered between the fixed ends.

“Super tensile steel (ST)” means a carbon steel with a tensile strength of at least 3650 MPa at 0.20 mm filament diameter.

“Tenacity” is stress expressed as force per unit linear density of the unstrained specimen (gm/tex or gm/denier). Used in textiles.

“Tensile” is stress expressed in forces/cross-sectional area. Strength in psi=12,800 times specific gravity times tenacity in grams per denier.

“Toe guard” refers to the circumferentially deployed elastomeric rim-contacting portion of the tire axially inward of each bead.

“Tread” means a molded rubber component which, when bonded to a tire casing, includes that portion of the tire that comes into contact with the road when the tire is normally inflated and under normal load.

“Tread element” or “traction element” means a rib or a block element.

“Tread width” means the arc length of the tread surface in a plane including the axis of rotation of the tire.

“Turnup end” means the portion of a carcass ply that turns upward (i.e., radially outward) from the beads about which the ply is wrapped.

“Ultra tensile steel (UT)” means a carbon steel with a tensile strength of at least 4000 MPa at 0.20 mm filament diameter.

“Vertical deflection” means the amount that a tire deflects under load.

“Yarn” is a generic term for a continuous strand of textile fibers or filaments. Yarn occurs in the following forms: (1) a number of fibers twisted together; (2) a number of filaments laid together without twist; (3) a number of filaments laid together with a degree of twist; (4) a single filament with or without twist (monofilament); and (5) a narrow strip of material with or without twist.

### SUMMARY

A radial tire in accordance with the present disclosure includes a pair of bead cores; a carcass having one or a plurality of carcass plies extending from one of the bead cores to the other of the bead cores in a toroidal form; a tread portion circumferentially encircling the toroidal form of the carcass; and a belt structure disposed radially between the carcass and the tread portion having a main belt layer, a first, unreinforced rubber layer disposed on a radially outer side of the main belt layer, a second, unreinforced rubber layer disposed within the main belt layer, and a protective belt layer disposed on a radially outer side of the first, unreinforced rubber layer and a radially inner side of the tread portion, a radially outermost belt ply of the main belt layer having a plurality of reinforcement cords each having a diameter, the first, unreinforced rubber layer having a first radial thickness between 0.5 and 4.0 times the diameter of the plurality of reinforcement cords of the radially outermost belt ply of the main belt layer, and the second, unreinforced rubber layer having a second radial thickness between 0.5 and 2.5 times the diameter of the plurality of reinforcement cords of the radially outermost belt ply of the main belt layer.

According to another aspect of the radial tire, the second, unreinforced rubber layer has a second radial thickness between 0.5 and 1.5 times the diameter of the plurality of reinforcement cords of the radially outermost belt ply of the main belt layer.

According to still another aspect of the radial tire, the second, unreinforced rubber layer has a second axial width in a range between 0.5 and 1.1 times an overall axial width of the belt structure.

According to yet another aspect of the radial tire, the first, unreinforced rubber layer has a first radial thickness in a range of between 0.5 and 3.0 times the diameter of the plurality of reinforcement cords of the radially outermost belt ply of the main belt layer.

According to still another aspect of the radial tire, the plurality of reinforcement cords of the radially outermost belt ply of the main belt layer is a plurality of organic fiber, merged cords.

According to yet another aspect of the radial tire, the carcass has organic fiber cords.

According to another aspect of the radial tire, the radial further comprises a third, unreinforced rubber layer disposed within the main belt layer radially inward of the second, unreinforced rubber layer.

According to still another aspect of the radial tire, the radial further comprises a third, unreinforced rubber layer disposed within the main belt layer radially outward of the second, unreinforced rubber layer.

According to yet another aspect of the radial tire, the third, unreinforced rubber layer has a third radial thickness in a range of between 0.5 and 2.5 times the diameter of the plurality of reinforcement cords of the radially outermost belt ply of the main belt layer.

According to another aspect of the radial tire, the third, unreinforced rubber layer has a third radial thickness in a range of between 0.5 and 1.5 times the diameter of the plurality of reinforcement cords of the radially outermost belt ply of the main belt layer.

According to still another aspect of the radial tire, the third, unreinforced rubber layer has a third axial width between 0.5 and 1.1 times an overall axial width of the belt structure.

Another radial tire in accordance with the present disclosure includes a pair of bead cores; a carcass having one or a plurality of carcass plies extending from one of the bead cores to the other of the bead cores in a toroidal form; a tread portion circumferentially encircling the toroidal form of the carcass; and a belt structure disposed radially between the carcass and the tread portion having a main belt layer, a first, unreinforced rubber layer disposed on a radially outer side of the main belt layer, a second, unreinforced rubber layer disposed within the main belt layer, a third, unreinforced rubber layer disposed within the main belt layer, and a protective belt layer disposed on a radially outer side of the first, unreinforced rubber layer and a radially inner side of the tread portion, a radially outermost belt ply of the main belt layer having a plurality of reinforcement cords each having a diameter, the first, unreinforced rubber layer having a first radial thickness between 0.5 and 4.0 times the diameter of the plurality of reinforcement cords of the radially outermost belt ply of the main belt layer, the second, unreinforced rubber layer having a second radial thickness between 0.5 and 2.5 times the diameter of the plurality of reinforcement cords of the radially outermost belt ply of the main belt layer, and the third, unreinforced rubber layer having a third radial thickness between 0.5 and 2.5 times the diameter of the plurality of reinforcement cords of the radially outermost belt ply of the main belt layer.

According to another aspect of the radial tire, the third, unreinforced rubber layer is disposed radially inward of the second, unreinforced rubber layer.

According to still another aspect of the radial tire, the third, unreinforced rubber layer is disposed radially outward of the second, unreinforced rubber layer.

According to yet another aspect of the radial tire, the second, unreinforced rubber layer has a second radial thickness in a range of between 0.5 and 1.5 times the diameter of the plurality of reinforcement cords of the radially outermost belt ply of the main belt layer.

According to still another aspect of the radial tire, the third, unreinforced rubber layer has a third radial thickness in a range of between 0.5 and 1.5 times the diameter of the plurality of reinforcement cords of the radially outermost belt ply of the main belt layer.

According to another aspect of the radial tire, the second and third, unreinforced rubber layers have a second and third axial width, respectively, in a range between 0.5 and 1.1 times an overall axial width of the belt structure.

### BRIEF DESCRIPTION OF THE DRAWINGS

The present disclosure will be described by way of example and with reference to the accompanying drawings, in which:

FIG. 1 is a cross-sectional view of one half of an example radial aircraft tire.

FIG. 2 is a partial cross-sectional view of one half of the example radial aircraft tire of FIG. 1.

FIG. 3 is a cross-sectional view of one half of another example radial aircraft tire.

The figures, dimensions, or numbers of elements in the drawings that describe examples of the present disclosure are merely illustrative and are not limiting. Further, like reference numerals in the drawings refer to like elements.

### DETAILED DESCRIPTION

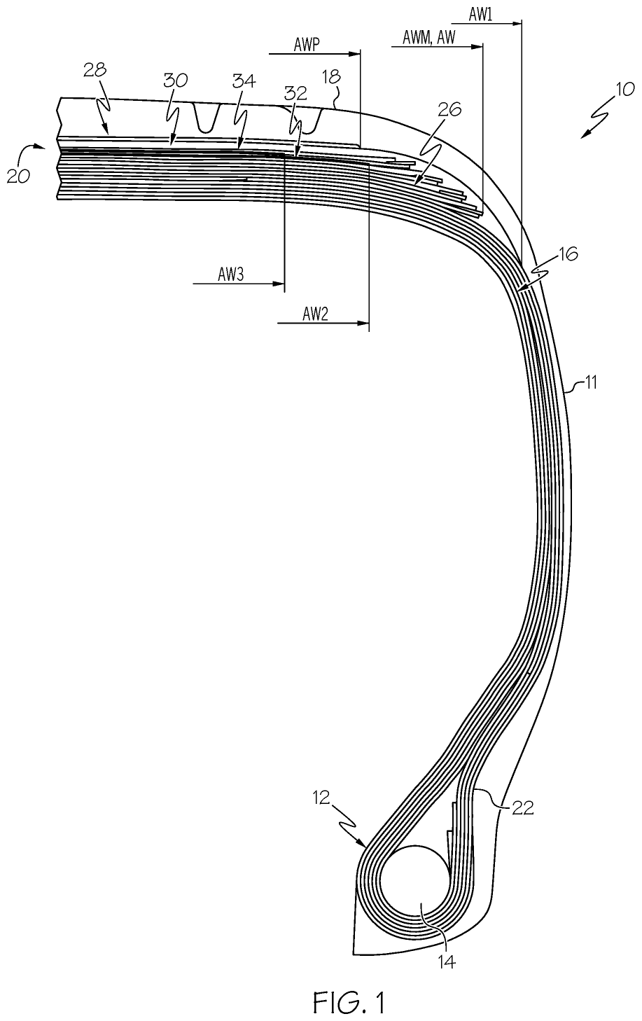

FIG. 1 illustrates a cross-sectional view of one half of an example radial aircraft tire 10 of the present disclosure. The tire 10 is symmetrical about an equatorial plane (EP) so that only one half of the tire 10 is illustrated. As shown, the tire 10 may have a pair of bead portions 12 each containing a bead core 14 embedded therein. Each bead core 14 may have a circular cross-section. Each bead core 14 may have an aluminum, aluminum alloy, or other light weight alloy in a center portion and a plurality of steel sheath wires surrounding the center portion. A person skilled in the art may appreciate that other bead cores may also be utilized.

The tire 10 may further comprise a sidewall portion 11 extending substantially radially outwardly from each of the bead portions 12 and a tread portion 18 extending substantially axially between the radially outer ends of the sidewall portions 11. Furthermore, the tire 10 may include a carcass 16 toroidally extending from one of the bead portions 12 to the other of the bead portions 12. The carcass 16 may include one carcass ply 22 or a plurality of carcass plies 22, such as for example, six or more carcass plies 22. In the example tire 10 of FIG. 1, the tire 10 includes six carcass plies 22. The one carcass ply 22 or plurality of carcass plies 22 may be wound around the bead portions 12 to form turnup portions. Also, the one carcass ply 22 or plurality of carcass plies 22 may comprise rubber-coated organic fiber cords arranged in a radial direction of the tire 10 and retained by the bead cores 14. Note that, since other structures, such as a flipper, a chafer, a chipper, etc. may be similar to conventional structures, they are not depicted in FIG. 1.

The one carcass ply 22 or each of the plurality of carcass plies 22 may utilize, in one example, an organic fiber cord having a tensile fracture strength of 6.3 cN/dtex or higher, an elongation percentage of 0.2 to 1.8 percent when a load is 0.2 cN/dtex in the elongating direction, an elongation percentage of 1.4 to 6.4 percent when a load is 1.0 cN/dtex in the elongating direction, and an elongation percentage of 2.1 to 8.6 percent when a load is 2.9 cN/dtex in the elongating direction. The organic fiber cord of the one carcass ply 22 or each of the plurality of carcass plies 22 may be an aromatic polyamide fiber with an inner-layer coefficient of 0.12 to 0.85, or 0.17 to 0.51, and an outer-layer coefficient of 0.4 to 0.85.

The one carcass ply 22 or each of the plurality of carcass plies 22 may utilize, in another example, an organic fiber cord having a tensile fracture strength of 6.3 cN/dtex or higher, an elongation percentage of 0.2 to 2.0 percent when a load is 0.3 cN/dtex in the elongating direction, an elongation percentage of 1.5 to 7.0 percent when a load is 2.1 cN/dtex in the elongating direction, and an elongation percentage of 2.2 to 9.3 percent when a load is 3.2 cN/dtex in the elongating direction. The organic fiber cord of the one carcass ply 22 or each of the plurality of carcass plies 22 may be an aromatic polyamide fiber with an inner-layer coefficient of 0.12 to 0.85, or 0.17 to 0.51, and an outer-layer coefficient of 0.4 to 0.85.

The organic fiber cord of the one carcass ply 22 or each of the plurality of carcass plies 22 may be a merged, or hybrid, cord including aromatic polyamide fiber and aliphatic polyamide fiber. The weight ratio of the aromatic polyamide fiber and the aliphatic polyamide fiber may be from 100:27 to 100:255. Additionally, nylon may be used for part or all of the merged cord.

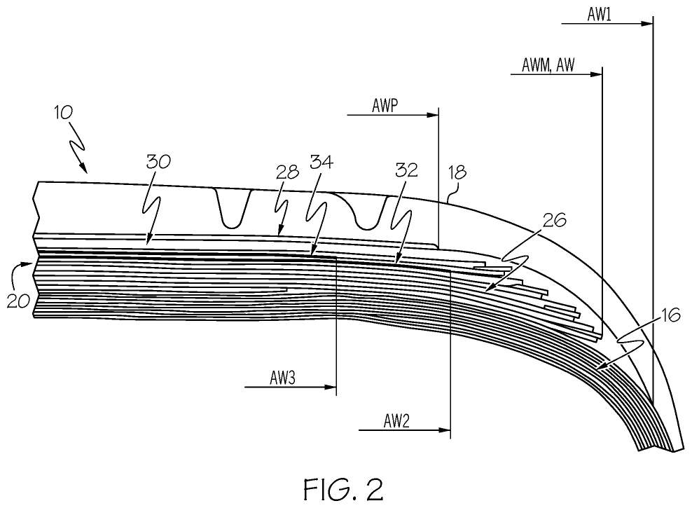

The example aircraft radial tire 10 may also have a belt structure 20 arranged radially between the carcass 16 and the tread portion 18. FIGS. 1 and 2 illustrate an example of one half of a belt structure 20 suitable for use in the example tire 10. The belt structure 20 may have an overall axial width AW. The belt structure 20 may include a main belt layer 26 and a protective belt layer 28. The main belt layer 26 may be disposed radially inward of the protective belt layer 28, such that the main belt layer 26 is disposed on a radially inner side of the belt structure 20 and the protective belt layer 28 is disposed on a radially outer side of the belt structure 20. The main belt layer 26 may have an axial width AWM, and the protective belt layer 28 may have an axial width AWP. In the example of FIGS. 1 and 2, the axial width AWM of the main belt layer 26 is the overall axial width AW of the belt structure 20. The axial width AWP of the protective belt layer 28 may be smaller or larger relative to the axial width AWM of the main belt layer 26. In some examples, a ratio of the axial width AWP of the protective belt layer 28 and the axial width AWM of the main belt layer 26 may be between 0.30 and 1.10. In other examples, the axial width AWP of the protective belt layer 28 may be 72 percent of the axial width AWM of the main belt layer 26.

The main belt layer 26 may include a plurality of belt plies, in a range of, for example, from two to 16 belt plies. The widths of the belt plies may be the same or vary relative to each other. Additionally, in one example, each of the plurality of belt plies of the main belt layer 26 may be formed with a plurality of reinforcement cords, wherein the plurality of reinforcement cords includes one or a plurality of organic fiber cords. Further, in another example, a radially outermost belt ply of the main belt layer 26 may be formed with a plurality of reinforcement cords, wherein the plurality of reinforcement cords includes one or a plurality of organic fiber cords. In either of the foregoing examples, the plurality of reinforcement cords may have a diameter. The diameter of each of the plurality of reinforcement cords may be 1.02 mm. Also, in either of the foregoing examples, the plurality of reinforcement cords may have a cord angle in a range of between 1 and 45 degrees, or 10 and 45 degrees, with respect to an equatorial plane EP of the tire 10. Also, in either of the foregoing examples, if the plurality of reinforcement cords includes a plurality of organic fiber cords, the density of the plurality of organic fiber cords may be in a range of between 4.0 cords/10 mm to 10.0 cords/10 mm, or 7.0 cords/10 mm.

In examples where the plurality of reinforcement cords of the main belt layer 26 includes one or a plurality of organic fiber cords, the one or plurality of organic fiber cords may be a merged or hybrid cord, including aromatic polyamide fiber and aliphatic polyamide fiber. The weight ratio of the aromatic polyamide fiber and the aliphatic polyamide fiber may be from 100:27 to 100:255. Additionally, nylon may be used for part or all of the example merged cord.

The protective belt layer 28 may be formed of one belt ply or a plurality of belt plies. Additionally, in one example, the one or plurality of belt plies of the protective belt layer 28 may be formed with a plurality of reinforcement cords, wherein the plurality of reinforcement cords includes one or a plurality of organic fiber cords. The one or plurality of organic fiber cords may be each coated with rubber to form band-like thin bodies wound such that, whenever the thin bodies are wound once, or 360 degrees, the thin bodies may reciprocate between both axial ends of the belt plies, and the thin bodies may be inclined at an angle of 0 to 45 degrees with respect to the equatorial plane (EP) of the tire 10, and this winding may be carried out many times while offsetting the thin bodies as substantially the same distance as their widths in the circumferential direction of the tire 10 such that no gap is generated between the thin bodies (this is called endless zigzag-wound belt, hereinafter), as disclosed in U.S. Pat. No. 7,712,499, hereby incorporated by reference in its entirety. As a result, the one or plurality of organic fiber cords, extending in substantially the circumferential direction of the tire 10 in a zigzag manner, may be embedded in the entire region of the one or plurality of belt plies of the protective belt layer 28 substantially uniformly by changing the bending direction at both axial ends of the belt plies. The plurality of reinforcement cords of the one or plurality of belt plies of the protective belt layer 28 may also have a cord angle, which may be greater than the cord angle of the one or plurality of organic fiber cords of the plurality of belt plies of the main belt layer 26.

In the protective belt layer 28, the plurality of reinforcement cords, which in some examples may be one or a plurality of organic fiber cords, may have an elastic modulus equal to or less than that of the clastic modulus of the plurality of reinforcement cords, which may be one or a plurality of organic fiber cords, of the main belt layer 26. Example organic fiber cords of the protective layer 28 may include an aliphatic polyamide fiber, such as nylon, or a merged cord with an aromatic polyamide fiber, such as aramid, and an aliphatic polyamide fiber, such as nylon. The protective belt layer 28 may include an endless zigzag-wound belt having a cord angle of the one or plurality of organic fiber cords being in a range of 0 to 45 degrees with respect to the tire equatorial plane, or an angle of 10 degrees.

As shown in FIGS. 1 and 2, the example aircraft radial tire 10 may additionally include a first, unreinforced (e.g., lacking cord reinforcement, etc.) rubber layer 30. In one example, the first, unreinforced rubber layer 30 may be disposed on a radially outer side of the main belt layer 26, or radially between the main belt layer 26 and the protective belt layer 28. The first unreinforced rubber layer 30 may have an axial width AW1. A minimum radial thickness of the first, unreinforced rubber layer 30 may be in a range of 2.0 mm to 10.0 mm, or 4.6 mm to 10.0 mm, or 4.5 mm. The first, unreinforced rubber layer 30 may also comprise a plurality of layers with an overall thickness within the above ranges, or more specifically, the first, unreinforced rubber layer 30 may have a radial thickness in a range of between 0.5 and 4.0 times the diameter of the plurality of reinforcement cords of the main belt layer 26. The protective belt layer 28 may be disposed on a radially outer side of the first, unreinforced rubber layer 30 and a radially inner side of a tread portion 18.

Moreover, as shown in FIGS. 1 and 2, the example tire 10 may include a second, unreinforced rubber layer 32. In one example, the second, unreinforced rubber layer 32 may be disposed within the main belt layer 26, and thus, radially inward relative to the first, unreinforced rubber layer 30. In another example, the second, unreinforced rubber layer 32 may be disposed within the main belt layer 26 between any two, adjacent belt plies of the plurality of belt plies of the main belt layer 26. In another example, the second, unreinforced rubber layer 32 may be disposed within the main belt layer 26 between two, radially outer, adjacent belt plies of the plurality of belt plies of the main belt layer 26. Further, in some examples, the example aircraft radial tire 10 may also include a third, unreinforced rubber layer 34, similar to the second, unreinforced rubber layer 32. In such examples, the second, unreinforced rubber layer 32 may be disposed between two, adjacent belt plies of the plurality of belt plies of the main belt layer 26, and the third, unreinforced rubber layer 34 may be disposed between any two, adjacent belt plies of the plurality of belt plies of the main belt layer 26 that are radially inward or radially outward from those of the second, unreinforced rubber layer 32. A minimum thickness of the second and third, unreinforced rubber layers 32, 34 may be in a range of 1.0 mm to 4.0 mm, or 2.0 mm. Also, in some examples, the second and third, unreinforced rubber layers 32, 34 may each include a plurality of layers. In such examples, an overall thickness of each second and third, unreinforced rubber layer 32, 34 may be within the above ranges, or more specifically, each second and third, unreinforced rubber layer 32, 34 may have a radial thickness in a range of between 0.5 and 2.5 times the diameter of the plurality of reinforcement cords of the main belt layer 26. Additionally, the second and third, unreinforced rubber layers 32, 34 may each have an axial width AW2, AW3, respectively. The axial width AW2, AW3 of each of the second and third, unreinforced rubber layer 32, 34 may be in a range of between 0.3 and 1.1 times the overall axial width AW of the belt structure 20, or as shown in FIGS. 1 and 2, the axial width AWM of the main belt layer 26.

In the example of FIGS. 1 and 2, the first, unreinforced rubber layer 30 is disposed radially outward of the main belt layer 26, the second, unreinforced rubber layer 32 is disposed radially between two, adjacent belt plies of the plurality of belt plies of the main belt layer 26, and the third, unreinforced rubber layer 34 is disposed between two, adjacent belt plies of the plurality of belt plies of the main belt layer 26 that are radially outward from belt plies between which the second, unreinforced rubber layer 32 is disposed.

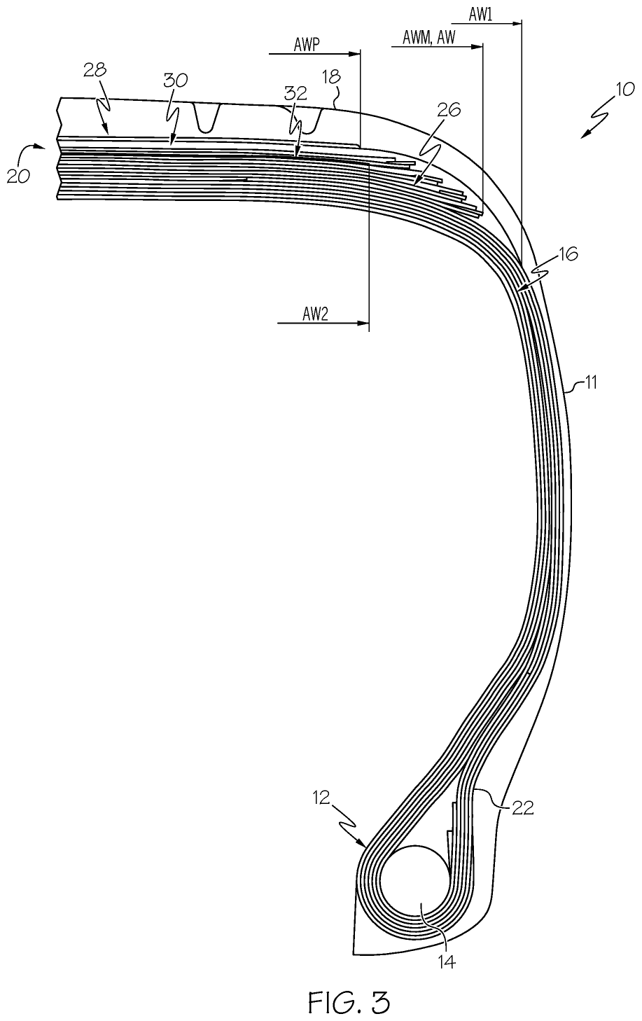

The example radial tire 10 of example of FIG. 3 is the same as the tire 10 in FIGS. 1 and 2 in all respects except that it includes only the first, unreinforced rubber layer 30 and the second, unreinforced rubber layer 32. In particular, the first, unreinforced rubber layer 30 is disposed radially outward of the main belt layer 26 and the second, unreinforced rubber layer 32 is disposed radially between two, adjacent belt plies of the plurality of belt plies of the main belt layer 26.

The above configurations of the rubber layers 30, 32, 34 result in an improved method of repairing the example aircraft radial tire 10 after penetration by a foreign object through the tread portion 18, the protective belt layer 28, the first, unreinforced rubber layer 30, and into the main belt layer 26 and the second, unreinforced rubber layer 32 and third, unreinforced rubber layer 34 (or, in other examples, such as in FIG. 3, only the second, unreinforced rubber layer 32). The repair process may involve removing the foreign object that has penetrated the foregoing portions of the tire 10. Then, the process may include buffing a surface of the first, unreinforced rubber layer 30 as well as within the cut damaged area using any suitable buffing means. Next, the process may include filling the cut damaged area with a repair rubber. When the example aircraft radial tire 10 is penetrated by the foreign object as far as into the main belt layer 26 and the second, unreinforced rubber layer 32 and the third, unreinforced rubber layer 34 (or, in other examples, only the second, unreinforced rubber layer 32), the adhesion of the repair rubber is improved as it can adhere to the second, unreinforced rubber layer 32 and third, unreinforced rubber layer 34 (or, in other examples, only the second, unreinforced rubber layer 32).

If the thickness of the rubber layers 30, 32, 34 is too small, when retreading the tire 10, it may become difficult to remove the rubber layers 30, 32, 34 without damaging the main belt layer 26. Conversely, if the thickness of the rubber layers 30, 32, 34 is too large, not only does the weight of the tire increase, but heat generation of the tread portion 18 also increases, which are both disadvantageous for the performance of the tire 10. The thickness of the first, unreinforced rubber layer 30 may allow removal of the protective layer 28 during retread operations.

The tire 10 according to the present disclosure has been described in detail. However, the present disclosure is not limited to the above example, and various modifications of the example may also apply. Numerous modifications and variations of the present disclosure are possible in light of the above teachings. It is therefore to be understood that within the scope of the appended claims, the present disclosure may be practiced otherwise than as specifically and exemplarily described herein.

Further, variations in the present disclosure are possible in light of the description of it provided herein. While certain representative embodiments and details have been shown for the purpose of illustrating the subject disclosure, it will be apparent to those skilled in this art that various changes and modifications can be made therein without departing from the scope of the subject disclosure. It is, therefore, to be understood that changes may be made in the particular examples described which will be within the fully intended scope of the present disclosure as defined by the following appended claims.

1. A radial tire comprising:
a pair of bead cores;
a carcass having one or a plurality of carcass plies extending from one of the bead cores to the other of the bead cores in a toroidal form;
a tread portion circumferentially encircling the toroidal form of the carcass; and
a belt structure disposed radially between the carcass and the tread portion having a main belt layer, a first, unreinforced rubber layer disposed on a radially outer side of the main belt layer, a second, unreinforced rubber layer disposed within the main belt layer, and a protective belt layer disposed on a radially outer side of the first, unreinforced rubber layer and a radially inner side of the tread portion, a radially outermost belt ply of the main belt layer having a plurality of reinforcement cords each having a diameter, the first, unreinforced rubber layer having a first radial thickness between 0.5 and 4.0 times the diameter of the plurality of reinforcement cords of the radially outermost belt ply of the main belt layer, the second, unreinforced rubber layer having a second radial thickness between 0.5 and 2.5 times the diameter of the plurality of reinforcement cords of the radially outermost belt ply of the main belt layer, and wherein the second, unreinforced rubber layer has a second axial width in a range between 0.5 and 1.1 times an overall axial width of the belt structure, and wherein the first, unreinforced rubber layer has a first axial width that is greater than the overall axial width of the belt structure.

2. The radial tire of claim 1, wherein the second, unreinforced rubber layer has a second radial thickness between 0.5 and 1.5 times the diameter of the plurality of reinforcement cords of the radially outermost belt ply of the main belt layer.

3. (canceled)

4. The radial tire of claim 1, wherein the first, unreinforced rubber layer has a first radial thickness in a range of between 0.5 and 3.0 times the diameter of the plurality of reinforcement cords of the radially outermost belt ply of the main belt layer.

5. The radial tire of claim 1, wherein the plurality of reinforcement cords of the radially outermost belt ply of the main belt layer is a plurality of organic fiber, merged cords.

6. The radial tire of claim 1, wherein the carcass has organic fiber cords.

7. The radial tire of claim 1, further comprising a third, unreinforced rubber layer disposed within the main belt layer radially inward of the second, unreinforced rubber layer.

8. The radial tire of claim 1, further comprising a third, unreinforced rubber layer disposed within the main belt layer radially outward of the second, unreinforced rubber layer.

9. The radial tire of claim 7, wherein the third, unreinforced rubber layer has a third radial thickness in a range of between 0.5 and 2.5 times the diameter of the plurality of reinforcement cords of the radially outermost belt ply of the main belt layer.

10. The radial tire of claim 8, wherein the third, unreinforced rubber layer has a third radial thickness in a range of between 0.5 and 2.5 times the diameter of the plurality of reinforcement cords of the radially outermost belt ply of the main belt layer.

11. The radial tire of claim 7, wherein the third, unreinforced rubber layer has a third radial thickness in a range of between 0.5 and 1.5 times the diameter of the plurality of reinforcement cords of the radially outermost belt ply of the main belt layer.

12. The radial tire of claim 8, wherein the third, unreinforced rubber layer has a third radial thickness in a range of between 0.5 and 1.5 times the diameter of the plurality of reinforcement cords of the radially outermost belt ply of the main belt layer.

13. The radial tire of claim 7, wherein the third, unreinforced rubber layer has a third axial width between 0.5 and 1.1 times an overall axial width of the belt structure.

14. The radial tire of claim 8, wherein the third, unreinforced rubber layer has a third axial width between 0.5 and 1.1 times an overall axial width of the belt structure.

15. A radial tire comprising:
a pair of bead cores;
a carcass having one or a plurality of carcass plies extending from one of the bead cores to the other of the bead cores in a toroidal form;
a tread portion circumferentially encircling the toroidal form of the carcass; and
a belt structure disposed radially between the carcass and the tread portion having a main belt layer, a first, unreinforced rubber layer disposed on a radially outer side of the main belt layer, a second, unreinforced rubber layer disposed within the main belt layer, a third, unreinforced rubber layer disposed within the main belt layer, and a protective belt layer disposed on a radially outer side of the first, unreinforced rubber layer and a radially inner side of the tread portion, a radially outermost belt ply of the main belt layer having a plurality of reinforcement cords each having a diameter, the first, unreinforced rubber layer having a first radial thickness between 0.5 and 4.0 times the diameter of the plurality of reinforcement cords of the radially outermost belt ply of the main belt layer, the second, unreinforced rubber layer having a second radial thickness between 0.5 and 2.5 times the diameter of the plurality of reinforcement cords of the radially outermost belt ply of the main belt layer, the third, unreinforced rubber layer having a third radial thickness between 0.5 and 2.5 times the diameter of the plurality of reinforcement cords of the radially outermost belt ply of the main belt layer, and wherein the second, unreinforced rubber layer has a second axial width in a range between 0.5 and 1.1 times an overall axial width of the belt structure, and wherein the first, unreinforced rubber layer has a first axial width that is greater than the overall axial width of the belt structure.

16. The radial tire of claim 15, wherein the third, unreinforced rubber layer is disposed radially inward of the second, unreinforced rubber layer.

17. The radial tire of claim 15, wherein the third, unreinforced rubber layer is disposed radially outward of the second, unreinforced rubber layer.

18. The radial tire of claim 15, wherein the second, unreinforced rubber layer has a second radial thickness in a range of between 0.5 and 1.5 times the diameter of the plurality of reinforcement cords of the radially outermost belt ply of the main belt layer.

19. The radial tire of claim 15, wherein the third, unreinforced rubber layer has a third radial thickness in a range of between 0.5 and 1.5 times the diameter of the plurality of reinforcement cords of the radially outermost belt ply of the main belt layer.

20. The radial tire of claim 15, wherein the third, unreinforced rubber layer has a third axial width in a range between 0.5 and 1.1 times an overall axial width of the belt structure.
